(19) United States
(12) Patent Application Publication
(10) Pub. No.: US 2024/0325886 A1
(43) Pub. Date: Oct. 3, 2024

(54) SYSTEMS AND METHODS FOR CAPTURING AND UTILIZING VIDEO GAME INPUT STATES

(71) Applicant: Netflix, Inc., Los Gatos, CA (US)

(72) Inventor: Olivier Jean Poitrey, Le Chesnay (FR)

(21) Appl. No.: 18/193,626

(22) Filed: Mar. 30, 2023

(51) Int. Cl. A63F 13/42; A63F 13/44

(52) U.S. Cl. CPC A63F 13/42; A63F 13/44

(57) ABSTRACT

The disclosed computer-implemented methods and systems can increase the speed and accuracy with which video games are played over the Internet. For example, the disclosed methods and systems can capture atomic input state information from a video game controller reflecting any buttons, joysticks, or other control elements that are currently selected. The disclosed methods and system can transmit an input state a first time, and then retransmit the input state in groups of future input states. As such, the methods and systems can keep the video game in a consistent input state, even if one or more input state transmissions are dropped. Various other methods, systems, and computer-readable media are also disclosed.

### BACKGROUND

Video games continue to be a popular and pervasive form of entertainment. Video gaming platforms constantly try to create video games that are faster, more exciting, and more immersive. Typically, a video game is played on a game console or computer that displays game graphics via a display device such as a TV or monitor, while a player interacts with the displayed game via a video game input device such as a video game controller or a touch screen display device. Such input devices generally include or display a collection of buttons, joysticks, track pads, paddles, and so forth. When a video game player interacts with an input device while playing a video game, the input device can transmit signals to the gaming system that cause the video game to generate different visual outputs based on how the player has interacted with the input device.

When the video game is played on a local console (i.e., a video game console that is either wired to a controller or on the same subnet as a wireless controller), the video game player may experience a high level of responsiveness that can help the video game seem more realistic. Despite this, problems can arise when the video game is played over a larger network. For example, a video game player may play a video game over the Internet such that the player interacts with an input device and the input device transmits input signals over the Internet to a remote game platform. The game platform can then cause the player's local video game display to update based on the received input signals.

This cycle of transmissions, however, can experience increased latency which can negatively impact video game performance. For example, the round-trip time for the input signals over the Internet may be long enough that the video game player can experience lag between when a button is pushed on the controller and when a corresponding video game update is displayed on the player's display device. While this lag may be very small, such transmission inefficiencies can cause gameplay to slow down to the point where the video game freezes, studders, or otherwise becomes difficult to play.

Additionally, input signals may be lost or dropped at any point during transmission over the Internet. To illustrate, if an input signal from a series of input signals (e.g., a series of button presses on the video game controller) is dropped, the video game platform may inaccurately update the display of the video game because of the missed input signal. This can result in player confusion, as well as computational waste due to gameplay being repeated, levels being restarted, the video game being reset, and so forth.

### SUMMARY

As will be described in greater detail below, the present disclosure describes implementations that blindly transmit and retransmit full input states of a video game controller over the Internet such that the corresponding video game can maintain a consistent input state. For example, implementations can include receiving, from a video game input device and in response to user interactions on the video game input device in connection with a video game displayed on a display device: 1) a transmission of a first input state message comprising a first input state of the video game input device, and 2) a predetermined number of retransmissions of the first input state, wherein the retransmissions of the first input state are received without providing an acknowledgement associated with the first input state, receiving, from the video game input device and in response to additional user interactions on the video game input device in connection with the video game: 1) a second input state message comprising a second input state of the video game input device and the first input state of the video game input device, and 2) the predetermined number of retransmissions of the second input state, wherein the retransmissions of the second input state are received without providing an acknowledgement associated with the second input state, and updating gameplay of the video game based on input state information received in the first input state message and the second input state message.

In some examples, the user interactions on the video game input device in connection with the video game can include at least one of single-finger touch gesture user interactions or multi-finger touch gesture user interactions. Additionally, implementations can further include receiving transmissions of control messages from the video game input device and utilizing the control messages for at least one of an initialization procedure with the video game input device, an authorization procedure with the video game input device, a device configuration procedure with the video game input device, or a disconnect procedure with the video game input device.

In some examples, implementations can also include, in response to receiving a transmission of a control message, generating an acknowledgement message associated with the control message and transmitting the acknowledgement message to the video game input device. For example, the first input state message, the second input state message, and the control messages further can include a device ID associated with the video game input device.

In some examples, the predetermined number of retransmissions can be defined by a retransmit factor included in at least one of the control messages. Additionally, the second input state message can further include a time delta that indicates a number of milliseconds that separate the first input state of the video game input device from a timestamp associated with the second input state message. Moreover, implementations can further include, in response to receiving no input state message transmissions from the video game input device for more than a threshold amount of time, determining that the video game input device is in an idle state.

Some examples described herein include a system with at least one physical processor and physical memory including computer-executable instructions that, when executed by the at least one physical processor, cause the at least one physical processor to perform various acts. In at least one example, the computer-executable instructions, when executed by the at least one physical processor, cause the at least one physical processor to perform acts including receiving, from a video game input device used as a video game controller and in response to user interactions on the video game input device in connection with a video game displayed on a display device: 1) a transmission of a first input state message comprising a first input state of the video game input device, and 2) a predetermined number of retransmissions of the first input state, wherein the retransmissions of the first input state are received without providing an acknowledgement associated with the first input state, receiving, from the video game input device and in response to additional user interactions on the video game input device in connection with the video game: 1) a second input state message comprising a second input state of the video game input device and the first input state of the video game input device, and 2) the predetermined number of retransmissions of the second input state, wherein the retransmissions of the second input state are received without providing an acknowledgement associated with the second input state, and updating gameplay of the video game based on input state information received in the first input state message and the second input state message.

In some examples, the above-described method is encoded as computer-readable instructions on a computer-readable medium. In one example, the computer-readable instructions, when executed by at least one processor of a computing device, cause the computing device to receive, from a video game input device used as a video game controller and in response to user interactions on the video game input device in connection with a video game displayed on a display device: 1) a transmission of a first input state message comprising a first input state of the video game input device, and 2) a predetermined number of retransmissions of the first input state, wherein the retransmissions of the first input state are received without providing an acknowledgement associated with the first input state, receive, from the video game input device and in response to additional user interactions on the video game input device in connection with the video game: 1) a second input state message comprising a second input state of the video game input device and the first input state of the video game input device, and 2) the predetermined number of retransmissions of the second input state, wherein the retransmissions of the second input state are received without providing an acknowledgement associated with the second input state, and update gameplay of the video game based on input state information received in the first input state message and the second input state message.

In one or more examples, features from any of the embodiments described herein are used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary environment for implementing an input state system in accordance with one or more implementations.

FIG. 2 is a flow diagram of an exemplary computer-implemented method for capturing and utilizing input state information in connection with a video game in accordance with one or more implementations.

FIGS. 3A-3C illustrate previous protocols for transmitting event data from a sender to a receiver.

FIGS. 3D-3F illustrate an input state protocol utilizing preventive blind retransmission for transmitting input state information with lower latency and increased accuracy in accordance with one or more implementations.

FIG. 4 illustrates a block diagram of the input state system in accordance with one or more implementations.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As mentioned above, video games that are played over the Internet can experience problems with latency and dropped input signals. These inefficiencies and inaccuracies can—in turn—lead to incorrect gameplay, player frustration, and corresponding computational waste. For example, a player may pause, restart, or reset a video game that is experiencing lag due to latencies over the network. Resource waste can result from any of these actions as network resources are used to transmit incorrect data, incorrect game graphics are rendered, systems are rebooted, and so forth.

In light of these problems, the present disclosure describes a system that captures and utilizes video game input states with increased efficiency and improved accuracy. For example, the system described herein can cause a video game controller to transmit atomic input state information over the Internet to a video game platform instead of transmitting individual events. By transmitting full input states each time a state change is detected (e.g., a new button is pressed), the system described herein can keep a consistent view of the video game controller's state at any given time. The system described herein can keep this consistent view even when signals and/or packets are dropped, coalesced, or split during transmission over the Internet.

In more detail, the system described herein can engage an input state protocol that utilizes preventive blind retransmission. In one or more implementations, the described system can cause the video game controller to transmit a current input state of the video game controller (e.g., reflecting which video game control elements have been interacted with), potentially in addition to other input states that have previously occurred. The system described herein can further cause the video game controller to retransmit input states a predetermined number of times without waiting on an acknowledgement message from the video game platform. By retransmitting each input state in the blind (e.g., without receiving an acknowledgement message), the systems described herein increase the speed with which input states are transmitted and received. Moreover, the system described herein increases gameplay accuracy by building a high level of redundancy into input state transmission such that gameplay can remain consistent even when a transmission is dropped.

Features from any of the implementations described herein may be used in combination with one another in accordance with the general principles described herein. These and other implementations, features, and advantages will be more fully understood upon reading the following detailed description in conjunction with the accompanying drawings and claims.

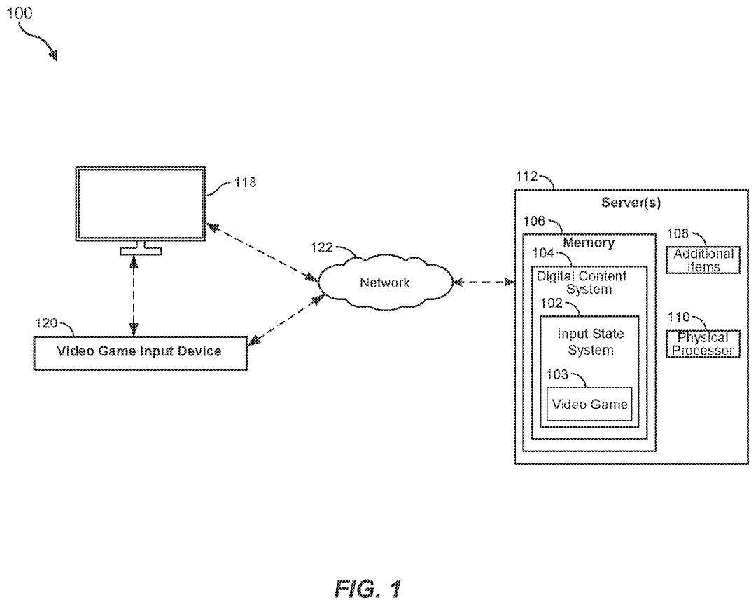

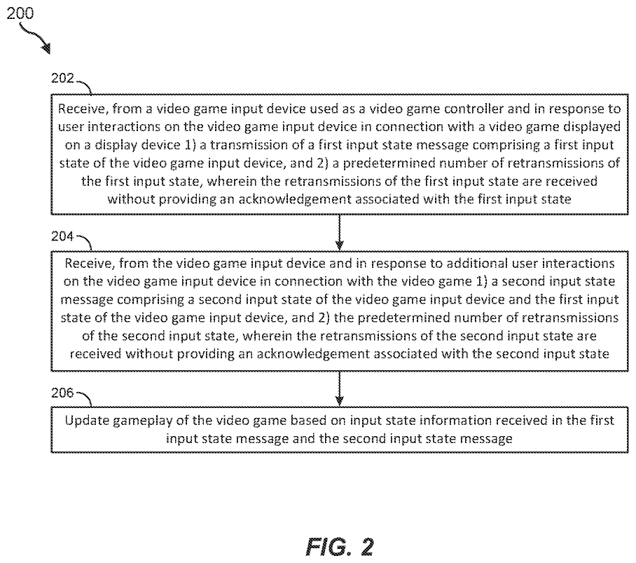

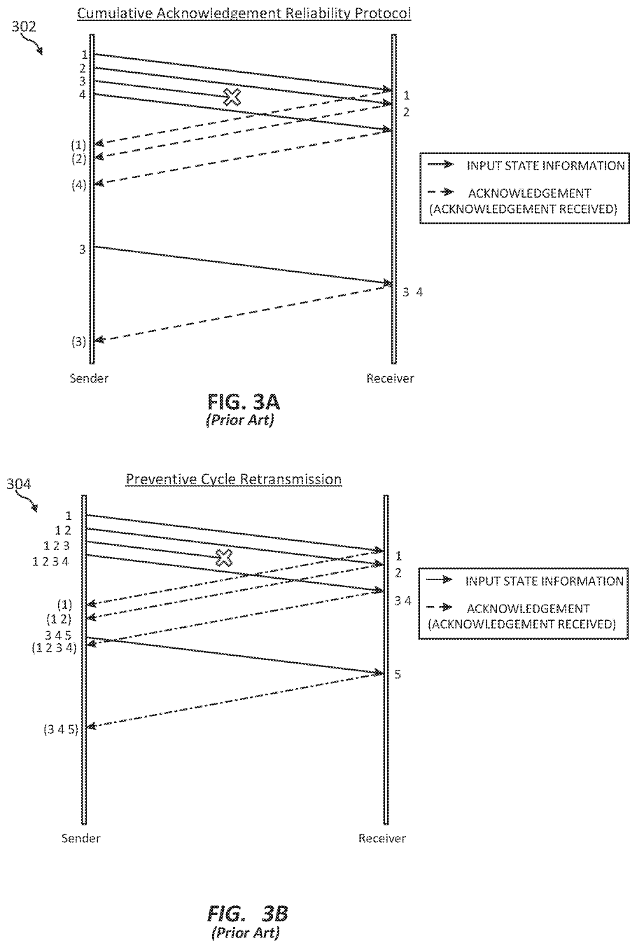

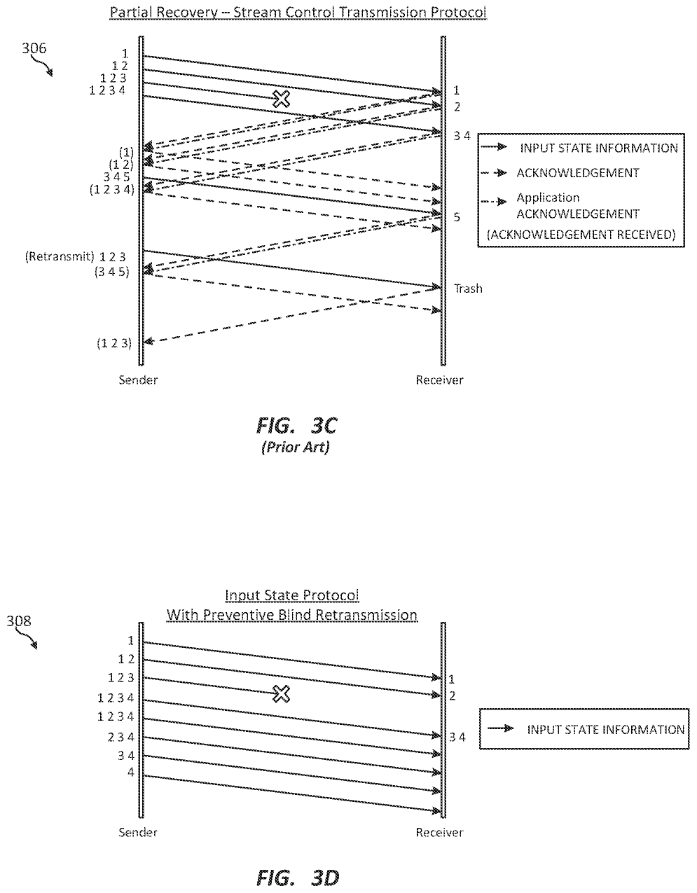

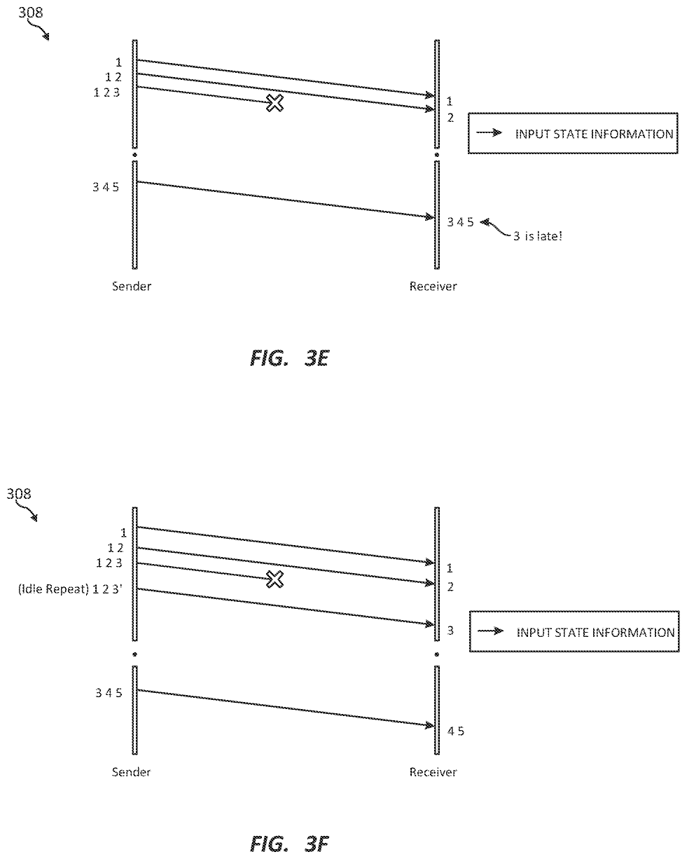

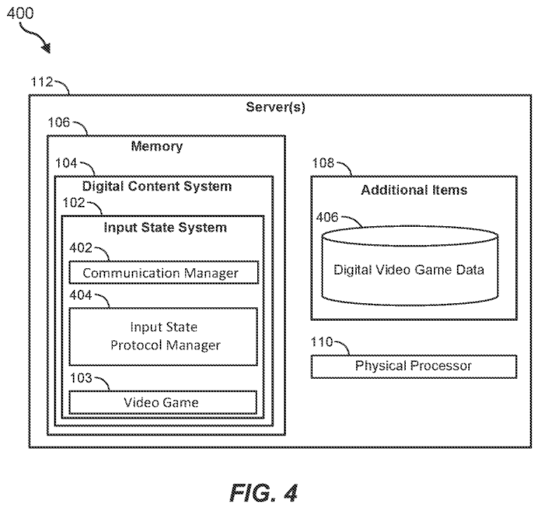

The following will provide, with reference to FIGS. 1-4, detailed descriptions of an input state system that causes a video game controller to transmit video game input states according to an input state protocol to capture current and previous input states of the video game controller accurately and efficiently. For example, an exemplary network environment is illustrated in FIG. 1 to show the input state system operating in connection with a display device and a video game input device (e.g., a video game controller). FIG. 2 illustrates steps taken by the input state system in receiving transmissions and retransmissions of input states without providing any acknowledgement messages to a video game input device being utilized as a video game controller. FIGS. 3A-3F describe operations and advantages of the input state protocol including preventive blind retransmission over existing transmission protocols. Finally, FIG. 4 provides additional detail with regard to the features and functionality of the input state system.

As just mentioned, FIG. 1 illustrates an exemplary networking environment 100 implementing aspects of the present disclosure. For example, the networking environment 100 can include server(s) 112, a display device 118, a video game input device 120, and a network 122. As further shown, the server(s) 112 can include a memory 106, additional items 108, and a physical processor 110.

In one or more implementations, as shown in FIG. 1, the display device 118 may be a television and the video game input device 120 may be any type of video game controller. For example, the video game input device 120 may be a display screen device such as a smartphone. In some examples, the display screen device being used as a video game controller may include a touch screen display showing video game control elements (e.g., buttons, joysticks, trackpads) that may serve to control the video game 103 displayed on the display device 118. In additional implementations, the video game input device 120 may be another type of input device. For example, the video game input device 120 may be a TV remote, a smart wearable (e.g., such as a smart watch), a virtual reality device, or a gamepad attached to the display device 118. In at least one implementation, the video game input device 120 may include a keyboard and/or mouse directly attached to a computing device such as a desktop computer, laptop computer, or tablet.

As further shown in FIG. 1, an input state system 102 may be implemented as part of a digital content system 104 within the memory 106 on the server(s) 112. In one or more implementations, the digital content system 104 may include a subscription streaming service for providing digital media content subscribers. Additionally, the input state system 102 (alone or in combination with the digital content system 104 and/or the video game 103) may access the video game 103, run the video game 103, stream output from the video game 103 to one or both of the display device 118 and the video game input device 120 (e.g., to cause the display device 118 to render game graphics, to cause the video game input device 120 to display video game control elements such as buttons, joysticks, etc.), receive input state messages and other transmissions from a video game controller (e.g., such as the video game input device 120), etc. In one or more implementations, the video game 103 can analyze input states, change game states, and update game graphics based on the input states, while the input state system 102 works in concert with the video game 103 to receiving transmissions from the video game input device 120 and transmit information to the video game input device 120.

As further shown in FIG. 1, the video game input device 120 may include the capability to communicate information to and from the input state system 102 via the network 122. In at least one implementation, the input state system 102—in concert with the video game 103—may access and utilize data received from the video game input device 120.

As mentioned above, the display device 118 and/or the video game input device 120 may be communicatively coupled with the server(s) 112 through the network 122. In one or more implementations, the network 122 may represent any type or form of communication network, such as the Internet, and may include one or more physical connections, such as a LAN, and/or wireless connections, such as a WAN. In some implementations, the network 122 may represent a telecommunications carrier network. In at least one implementation, the network 122 may represent combinations of networks such that the display device 118 may communicate with the digital content system 104 via a wireless network while the video game input device 120 may communicate with the input state system 102 via a cellular network.

Although FIG. 1 illustrates components of the exemplary networking environment 100 in one arrangement, other arrangements are possible. For example, in one implementation, the input state system 102 can operate as a native application that may be installed on the display device 118, and/or the video game input device 120. In another implementation, the input state system 102 may operate across multiple servers.

Moreover, in some implementations, the exemplary networking environment 100 may include multiple video game input devices 120—such as when a multiplayer game is being played on the display device 118. Similarly, the exemplary networking environment 100 may also include multiple display devices 118 such as when multiple players are playing a video game on separate displays. For example, in that implementation, the input system 102 and/or the digital content system 104 can support the same video game being played by multiple players (e.g., on multiple video game input devices and multiple display devices) across multiple locations and on different user accounts within the digital content system 104.

In one or more implementations, and as will be explained in greater detail below, the methods and steps performed by the input state system 102 reference multiple terms. For example, a “digital video game” or “video game” can refer to a digital program that causes game graphics to be rendered on a display device, such as the display device 118, as user inputs received via a video game input device manipulate or interact with the rendered game graphics. A video game may include points, places, junctures, levels, characters, and other displayed objects.

As used herein, a “video game input device” can include any device capable of receiving user inputs and transmitting signals associated with those inputs to a game platform. For example, a video game input device can include a video game controller that is specific to the game platform and may include any combination of physical buttons, joysticks, paddles, trackpads, etc. Additionally, a video game input device can include a client device such as a smartphone that has been converted into a video game controller. For example, a smartphone that has been converted into a video game controller may display graphical representations of buttons, joysticks, paddles, trackpads, etc. on a touch screen display. Moreover, a video game input device may include a mouse, keyboard, trackpad, etc. that is directly connected to a computing device such as a desktop computer, a laptop computer, a tablet computer, or so forth. In some implementations, the input state system 102 can detect and utilize input state information from multiple video game input devices (e.g., such as when a video game is played with both a computer keyboard and a mouse).

As used herein, “video game control elements” can refer to physical or graphically displayed buttons, joysticks, trackpads, roller balls, paddles, and so forth. For example, a video game control element can be an interactive graphic that mimics a button. In some implementations, a graphically displayed video game control element can appear to be depressed or otherwise manipulated when selected. In some implementations, video game control elements can refer to other types of displayed interactive graphics. For example, a video game control element may be specific and customized to a particular video game. To illustrate, a video game control element can include a depiction of an enemy character that, in response to a detected selection on the display screen device, is destroyed within the video game. In another example, video game control elements can include two displayed objects (e.g., a stone and a piece of wood) that can be dragged together on the touch screen display of the display screen device to be combined into a new video game control element (e.g., a tool).

As used herein, an “input state” can refer to data that reflects any video game control element on a video game input device that is not in its default state at a given time. For example, an input state of a video game input device with video game control elements can reflect which video game control elements are being interacted with or selected at a particular moment in time. In one or more implementations, the input state system can capture an input state of a video game controller in response to detecting an “event” or “input event.” For example, an event can include a player interaction with one or more video game control elements on the video game controller.

As used herein, a “transmission” can refer to communicating information over a network. Additionally, a “retransmission” can refer to an additional communication of previously sent information that is sent to the same endpoint as the previous transmission. In one or more implementations, the input state system can transmit various types of messages. For example, the input state system can transmit input state messages that can include input state information. The input state system can also transmit control messages that can include control information related to the video game input device, the current session, etc. Additionally, the input state system 102 can transmit an acknowledgement message that can acknowledge receipt of a previous transmission. In one or more implementations, the input state system can format and transmit messages according to an input state protocol that include preventive blind retransmission discussed in greater detail below with regard to FIG. 4.

As mentioned above, FIG. 2 is a flow diagram of an exemplary computer-implemented method 200 for capturing atomic input states from the video game input device 120 in connection with the video game 103. The steps shown in FIG. 2 may be performed by any suitable computer-executable code and/or computing system, including the system(s) illustrated in FIG. 4. In one example, each of the steps shown in FIG. 2 may represent an algorithm whose structure includes and/or is represented by multiple sub-steps, examples of which will be provided in greater detail below.

As illustrated in FIG. 2, at step 202 the input state system 102 can receive, from a video game input device used as a video game controller and in response to user interactions on the video game input device in connection with a video game displayed on a display device, 1) a transmission of a first input state message comprising a first input state of the video game input device, and 2) a predetermined number of retransmissions of the first input state, wherein the retransmissions of the first input state are received without providing an acknowledgement associated with the first input state.

For example, the input state system 102 can cause the video game input device 120 to generate and transmit the first input state message in response to detecting user inputs via a touch screen display on the video game input device 120. The input state system 102 can cause the video game input device 120 to generate the first input state message including the first input state that indicates one or more video game control elements with which the player has interacted. The input state system 102 further causes the video game input device 120 to blindly retransmit the first input state a predetermined number of times (e.g., five times) without waiting on acknowledgement messages associated with the first input state. In one or more implementations, the input state system 102 can cause the video game input device 120 to retransmit the first input state by grouping the first input state with additional input states in future input state messages.

As further illustrated in FIG. 2, at step 204 the input state system 102 can receive, from the video game input device and in response to additional user interactions on the video game input device in connection with the video game, 1) a second input state message comprising a second input state of the video game input device and the first input state of the video game input device, and 2) the predetermined number of retransmissions of the second input state, wherein the retransmissions of the second input state are received without providing an acknowledgement associated with the second input state.

For example, as mentioned above, the input state system 102 can cause the video game input device 120 to generate the second input state message including the most recently captured second input state (e.g., a second video game control element or group of video game control elements with which the player has interacted) as well as the first input state that was previously transmitted. As such, the second input state message can include a first transmission of the second input state and a retransmission (e.g., a second transmission) of the first input state. As with the first input state, the input state system 102 can cause the video game input device 120 to retransmit the second input state a predetermined number of times by grouping the second input state into future input state messages along with the first input state.

Additionally, as illustrated in FIG. 2, at step 206 the input state system 102 can update gameplay of the video game based on input state information received in the first input state message and the second input state message. For example, the input state system 102 can utilize the transmissions and retransmissions of the various input states received from the video game input device 120 to generate a consistent view of the input state of the video game input device 120 at any given time. This remains true even when messages are dropped during transmission over the Internet because of the redundancy included in the retransmissions.

As discussed above, the input state system 102 can receive input state information from an input device that is being used as a video game controller. As mentioned above, the input state system 102 can utilize the preventive blind retransmission protocol with any type of video game controller (e.g., a TV remote, a wired gamepad, a keyboard and mouse attached to a PC browser). In at least one implementation, the video game input device 120 (e.g., a player's smartphone) may be converted to a video game controller where one or more video game control elements are displayed on a touch screen display of the video game input device 120.

In one or more implementations, as mentioned above, the input state system 102 can cause the video game input device 120 to detect input states and transmit input state messages to the server(s) 112. To illustrate, the video game input device 120 can detect an input event including a selection of a left-direction video game control element and a simultaneous selection of a run video game control element (e.g., the player is making their character run left). The video game input device 120 can next detect an input event including a selection of a jump video game control element (e.g., the player is making their character jump). Finally, the video game input device 120 can detect an input event including a release of all video game control elements. In terms of individual events, this sequence of selections can be represented as:
Event 1: press left-direction video game control element+run video game control element
Event 2: press jump video game control element
Event 3: release jump video game control element
Event 4: release left-direction video game control element+run video game control element

In one or more implementations, the video game input device 120 can detect the following states in response to these detected selections:
State 1: left-direction video game control element+run video game control element
State 2: left-direction video game control element+run video game control element+jump video game control element
State 3: left-direction video game control element+run video game control element
State 4: nothing

In at least one implementation, the input state system 102 can effectively keep a consistent view of the input state of the video game input device 120 by receiving each state change atomically. This can be especially important if one or more of the detected states is transferred over the Internet because network queues along the way can coalesce or split some input states that should not be split.

Additionally, by receiving each state change atomically, the input state system 102 can effectively handle input state message drops. For example, if an input state message associated with State 3 is dropped, the input state system 102 can imply the events associated with State 3 based on the events of State 4 (i.e., all video game control elements released). Thus, for example, the input state system 102 can avoid missing video game control element releases by utilizing atomic full state transmission.

In one or more implementations, the input state system 102 can handle various challenges associated with atomic full state transmission. For example, relative coordinates can be used for mouse input devices (with pointer lock enabled) or for accelerometers. For example, movement of a mouse can be captured as:

$$X : \text{+1} , Y : \text{-1} . \qquad 1$$

$$X : \text{+1} , Y : \text{-2} . \qquad 2$$

$$X : \text{+1} , Y : \text{-3} . \qquad 3$$

As such, to determine the total movement of the mouse during a single game loop, all of the X and Y coordinates would need to be added together. If one of the event messages is lost during transmission, the end result would be incorrect.

As such, the input state system 102 can solve this issue by utilizing absolute values for relative events. For example, the input device can start at X=0 and Y=0. The input state system 102 can then apply the relative change on each state change using a wrapped around unsigned number to encode the new value. For example, by applying the relative change, mouse movements can be transmitted as:

$$X : 1 , Y : 4.294967295 \times {10}^{9} \qquad 1$$

$$X : 2 , Y : 4.294967293 \times {10}^{9} \qquad 2$$

$$X : 3 , Y : 4.29496729 \times {10}^{9} \qquad 3$$

As discussed above, a main goal of the input state system 102 is to reduce latency in input state transmission to improve performance related to the video game 103. FIGS. 3A-3C illustrate issues related to previously utilized transmission algorithms. For example, as shown in FIG. 3A, transmission control protocol (TCP) can include a cumulative acknowledgement reliability protocol 302 where a sender must wait on acknowledgement messages from the receiver.

To illustrate, a sender may transmit messages for events 1-4 to a receiver. As shown in FIG. 3A, event 3 may be dropped at some point during transmission and not received by the receiver. As such, the receiver may transmit acknowledgements back to the sender that are associated with events 1, 2, and 4. In response to determining that event 3 was not acknowledged by the receiver, the sender can retransmit event 3. The receiver can then transmit an acknowledgement of event 3 back to the sender. As such, the event 3 can take the time of two round trips to be retransmitted, which can delay all subsequent events. This protocol also offers no way to abandon event 3, which may be preferable when there is excessive delay.

Some systems seek to improve the cumulative acknowledgement reliability protocol latency issue by preventatively retransmitting messages until an acknowledgement message from the receiver. For example, as shown in FIG. 3B, some systems utilize preventive cycle retransmission 304 where events can be grouped together. To illustrate, the sender can transmit event 1, a group including events 1 and 2, a group including events 1-3, and a group including events 1-4. The receiver may acknowledge events 1, 2, 3, and 4 even though the group including events 1-3 is dropped during transmission. In response to receiving acknowledgements of events 1 and 2, the sender can transmit a group including events 3, 4, and 5 because acknowledgements of events 3 and 4 have not yet been received from the receiver. The sender can then receive an acknowledgement of event 5 from the receiver. In the example shown in FIG. 3B, losing the group of events 1-3 has a minimal impact on latency because the next group of events repeats any previously unacknowledged events (e.g., the message including the group of events 1-4).

While preventive cycle retransmission may improve transmission latency, the input state system 102 seeks to add a layer of security-particularly when used in connection with particular data channels such as a web real-time communication (WebRTC) data channel. As illustrated in FIG. 3C, some previous systems addressed this situation with a partial recovery-stream control transmission protocol 306 (PR-SCTP). In one or more implementations, the PR-SCTP 306 can create separate multiplexed reliable sub-streams with an ability to set a timeout or maximum number of retries on retransmits as well as unordered delivery. As shown in FIG. 3C and similarly to preventive cycle retransmission 304, the PR-SCTP 306 can transmit groups of events and retransmit unacknowledged events. The PR-SCTP 306 also adds application acknowledgements of events in addition to sender level acknowledgements within the PR-SCTP layer.

Even with the efficiencies introduced by the PR-SCTP 306, relying on receiver acknowledgements can introduce unwanted latency. As such, the input state system 102 improves the cumulative acknowledgement reliability protocol 302, preventive cycle retransmission 304, and the PR-SCTP 306 by removing such reliance on receiver acknowledgements. For example, as shown in FIG. 3D, the input state system 102 can engage an input state protocol with preventive blind retransmission 308 that retransmits events blindly a predetermined number of times regardless of any acknowledgements from the receiver. For example, as shown in FIG. 3D, the input state system 102 can transmit and retransmit each detected event the predetermined number of times (e.g., five times) without any acknowledgements from the receiver.

In one or more implementations, the predetermined number is selected to cover most event losses over the Internet. In the event that all packets containing a particular event are dropped, the input state system 102 can stay in a consistent input state because full atomic states are transmitted with each packet. To illustrate, if all packets associated with event 2 are dropped (e.g., the second through sixth packets), the input state system 102 still receives packets associated with events 3 and 4 due to full atomic state retransmission.

As discussed above, the input state system 102 causes the video game input device 120 to transmit and retransmit input state information in response to an event (e.g., a detected selection of one or more video game control elements on the video game input device 120). This, however, may create an issue when the video game 103 is slow-paced and only a few buttons are pressed followed by no additional events for a few seconds. Thus, as shown in FIG. 3E, the last detected event (e.g., event 3) may not be preventively retransmitted until the next event (e.g., event 4) is detected. As such, when the packet associated with the last detected event is dropped, the receiver receives the last detected event (e.g., event 3) late.

To solve this issue, the input state system 102 can determine that the sender (e.g., the video game input device 120) is in an idle state. As shown in FIG. 3F, the input state system 102 can cause the video game input device 120 to retransmit the last group of events when no new events are detected for a threshold amount of time until the predetermined number of retransmits for each event in the group of events is reached.

As mentioned above, and as shown in FIG. 4, the input state system 102 performs various functions in connection with transmitting and retransmitting input states of the video game input device 120 to maintain a consistent input state in connection with the video game 103. FIG. 4 is a block diagram 400 of the input state system 102 operating within the memory 106 of the server(s) 112 while performing these functions. As such, FIG. 4 provides additional detail with regard to these functions. For example, as shown in FIG. 4, the input state system 102 can include a communication manager 402 and an input state protocol manager 404 along with the video game 103. As further shown in FIG. 4, the additional items 108 can store and maintain digital video game data 406.

In certain implementations, the input state system 102 may represent one or more software applications, modules, or programs that, when executed by a computing device, may cause the computing device to perform one or more tasks. For example, and as will be described in greater detail below, one or more of the communication manager 402, the input state protocol manager 404, or the video game 103 may represent software stored and configured to run on one or more computing devices, such as the server(s) 112. One or more of the communication manager 402, the input state protocol manager 404, and the video game 103 of the input state system 102 shown in FIG. 4 may also represent all or portions of one or more special purpose computers to perform one or more tasks.

As mentioned above, and as shown in FIG. 4, the input state system 102 can include the communication manager 402. In one or more implementations, the communication manager 402 can transmit and receive data at the server(s) 112. In at least one implementation, the communication manager 402 can further cause the video game input device 120 to send and receive data.

As mentioned above, and as shown in FIG. 4, the input state system 102 can include the input state protocol manager 404. In one or more implementations, the input state protocol manager 404 enforces the input state protocol with preventive blind retransmission 08 between the video game input device 120 and the server(s) 112. For example, the input state protocol manager 404 can enforce the input state protocol with preventive blind retransmission 308 according to a protocol definition. In at least one implementation, the protocol definition can include two types of messages: control messages and input state messages. For instance, the input state protocol manager 404 can use control messages for initialization procedures, authorization procedures, define configuration procedures, and disconnect procedures. In one or more implementations, the input state protocol manager 404 can cause the video game input device 120 and/or the server(s) 112 to retransmit control messages until a corresponding acknowledgement message is received. Additionally, the input state protocol manager 404 can blindly retransmit input state messages to carry one or more input states from the video game input device 120 without any type of acknowledgement messages.

The protocol definition for the input state protocol with preventive blind retransmission 308 is now discussed in greater detail. In one or more implementations, the input state protocol is a binary protocol that functions in a binary format with ordered bits representing various data. In this way, the input state protocol is extremely space efficient such that control messages and input state messages are very small. This efficiency allows for the input state system 102 to build input state redundancy into input state messages with minimal cost in terms of message size and transmission speed. For ease of discussion, the input state protocol is described below to show the various types of information that are indicated by groups of bits within the structured control messages and input state messages. It will be understood that while the input state protocol is described verbosely, the input state protocol may be implemented in its binary form.

In more detail, the input state protocol manager 404 can include certain data in control message headers. For example, the input state protocol manager 404 can include the following information in the header of a control message:
“s” (1 bit): the input state protocol manager 404 can use this bit to differentiate between control messages and input state messages. In at least one implementation, the input state protocol manager 404 can set “s” to zero on control messages.
“Version” (7 bits): the input state protocol manager 404 can indicate the version of the preventive blind retransmission protocol being used with these bits.
“Device ID” (24 bits): the input state protocol manager 404 can indicate the device ID of the video game input device 120 that messages are being sent to and received from with these bits. In at least one implementation, the input state protocol manager 404 can multiplex several devices on the same underlying transport channel based on their device IDs. For example, the “Device ID” may be unique across all controller devices connected to a given instance of the video game 103. Once negotiated, the input state protocol manager 404 can use the same “Device ID” for the whole life of the input state system 102 during a given game session. The IP address of the video game input device 120 or the underlying transport may change without affecting the input states (e.g., sequence numbers, device configuration, authorization) of the video game input device 120.
“Flags” (4 bits): the input state protocol manager 404 can use flags for connection management. “Flags” can include:
   “Ack” (1 bit): the input state protocol manager 404 can use this flag in acknowledgement messages.
   “Ini” (2 bits): the input state protocol manager 404 can use this flag to initialize the connection of a new controller device.
   “Fin” (4 bits): the input state protocol manager 404 can use this flag to indicate an intent to disconnect the video game input device 120.
   “Rco” (8 bits): the input state protocol manager 404 can use this flag to reassociate a session to a different underlying transport or data channel. For example, in case of reconnection of the underlying transport protocol, the input state protocol manager 404 can send a control message with the “Rco” flag set to reclaim the communication for the “Device ID.” Unless a valid control message with the “Rco” flag set is sent by the video game input device 120 and a valid control message with the “Ack” flag is received by the video game input device 120, the input state protocol manager 404 can prevent the video game input device 120 from sending any additional input state messages and control messages.
“Session ID” (32 bits): the input state protocol manager 404 can cause the video game input device 120 to generate the “Session ID” as part of initialization and can use the “Session ID” to add security and ease routing of messages. During handshake, the input state protocol manager 404 can validate that the “Session ID” is not already used and can generate a random “Device ID” that is not already used. After the handshake, the input state protocol manager 404 can tie the “Device ID” and the “Session ID” together such that no control message may be accepted for a “Device ID” with a different “Session ID.” As such, the “Session ID” can protect a message for a given “Device ID” from attackers that may try to exploit the fact that the lifetime of a device connection is not tied to the lifetime of the underlying secure protocol.
“Control Sequence Number” (32 bits): the input state protocol manager 404 adds a sequence number to each message. For example, the input state protocol manager 404 can increment the “Control Sequence Number” by one for each message.
“Acknowledgement Number” (32 bits): when the “Ack” flag is set, the input state protocol manager 404 can use the “Acknowledgement Number” to represent the peer control sequence number this message acknowledges.
“Timestamp” (32 bits): the input state protocol manager 404 indicates the “Timestamp” as the number of milliseconds since the epoch negotiated at initialization (e.g., handshake). The input state protocol manager 404 can update the timestamp on control messages on each retransmit.

In addition to control message headers, the input state protocol manager 404 can also include certain data in input state message headers. For example, the input state protocol manager 404 can include the following information in the header of an input state message header:
“s” (1 bit): the input state protocol manager 404 can set “s” to one on input state messages.
“Version” (7 bits): the input state protocol manager 404 can indicate the version of the preventive blind retransmission protocol being used with these bits.
“Device ID” (24 bits): the input state protocol manager 404 can indicate the device ID of the video game input device 120 that messages are being sent to and received from with these bits.
“States Group Sequence Number” (32 bits): the input state protocol manager 404 can use the “States Group Sequence Number” to indicate a sequence number of the first group of input states. This sequence number may be separate from the “Control Sequence Number” and the input state protocol manager 404 can increment the “States Group Sequence Number” by one for each new input states group.
“Timestamp” (32 bits): the input state protocol manager 404 indicates the “Timestamp” as the number of milliseconds since the epoch negotiated at initialization (e.g., handshake).

In one or more implementations, before receiving input state messages from the video game input device 120 the input state protocol manager 404 can initialize the video game input device 120. For example, the input state protocol manager 404 can initialize the video game input device 120 by causing the video game input device 120 to send a control message to the server(s) 112 that includes:
The “Ini” flag set to one in the control message header.
The “Session ID” set to a random value in the control message header.
The “Control Sequence Number” set to another random value and wrapped around. In at least one implementation, the input state protocol manager 404 can set the “States Group Sequence Number” to the same random value.
The input state protocol manager 404 can also include configuration instructions to declare input capabilities and authorize the connection, as discussed in greater detail below).

In response to receiving this control message at the server(s) 112, the input state protocol manager 404 can generate and transmit a control message back to the video game input device 120 including:
The “Ini” and “Ack” flags set to one.
The “Device ID” set to a randomly generated ID unique to a current game session.
The “Control Sequence Number” set with a randomly generated server sequence number.
The “Acknowledgement Number” set to the “Control Sequence Number” received from the video game input device 120.

In one or more implementations, the input state protocol manager 404 can retransmit the initialization control message to the video game input device 120 until an acknowledgement message is received from the video game input device 120. In at least one implementation, the input state protocol manager 404 can further send an additional acknowledgement message to the video game input device 120 in response to receiving the acknowledgement message from the video game input device 120 (i.e., a two-way handshake).

In some implementations, the input state protocol manager 404 can include an input authorization secret token as part of an authorization flow. For example, the input state protocol manager 404 may not allocate resources if the input authorization secret token is not accepted. The input state protocol manager 404 may further implement additional protection at the server(s) 112 by accepting to allocate a limited number of “Device IDs” per connection flow. By making it so that only one secret token is valued at a time, the input state protocol manager 404 can avoid certain types of attacks. The input state protocol manager 404 may send initialization control messages at any point during the lifetime of the connection.

When the video game input device 120 or the server(s) 112 wants to terminate the connection, the input state protocol manager 404 can send a control message with the “Fin” flag set. In one or more implementations, a disconnection of the preventive blind retransmission protocol may not terminate an established input communication. For example, a websocket may reconnect to the same endpoint and resume the communication with the last known “Device ID”/“Sequence ID.” In order to associate a “Device ID” with this new established connection, the input state protocol manager 404 may send a control message with the “RCO” flag set to a matching “Device ID”/“Session ID” pair. In at least one implementation, the input state protocol manager 404 may not accept any input state information on a new connection from a device before a valid control message with either the “Ini” or the “Rco” flag is received.

In some implementations, the input state protocol manager 404 can use the “Session ID” during handshake when a websocket reflector is being used. For example, the input state protocol manager 404 can use the “Session ID” to route the traffic back to the client for “Ini”+“Ack” control messages or “Rco”+ “Ack” control messages. In that implementations, the websocket reflector may associate the “Device ID” with the “Session ID” based on the “Ack” control message from the input state protocol manager 404. In one or more implementations, the input state protocol manager 404 can set the “Session ID” to zero for any control message to the video game input device 120 that has the “Rco” or “Ini” flag set to avoid leaking this information to an attacker.

With regard to acknowledgement control messages, the input state protocol manager 404 can proactively cause control messages to be retransmitted until a control message with the “Ack” flag set to one with the sequence number of the message indicated by the “Acknowledgement Number” field. In at least one implementation, the input state protocol manager 404 can delay retransmission of control messages by ten milliseconds with an exponential backoff of up to one second.

In the event that a control message with the “Ack” flag set to one does not contain any other data, the input state protocol manager 404 may not increment the “Sequence Number.” Instead, the input state protocol manager 404 may set the “Sequence Number” to zero and not send any corresponding “Ack” control message back.

In one or more implementations, the input state protocol manager 404 may create an acknowledgement for each control message received that has the “Ini,” “Rco,” or “Fin” flag set and/or has a non-zero body. This may be true even if the sequence has already been received. Instead, the input state protocol manager 404 can buffer control messages for re-ordering and then interpret the control messages in order with no gap. If a new control message is too far out in the future for reordering purposes, the input state protocol manager 404 can close and then re-establish the connection.

With regard to timestamps, the input state protocol manager 404 can start the “Timestamp” field at zero in the first control message (e.g., the handshake). All subsequent messages may include that initial value as a reference (e.g., an epoch) with the difference added in milliseconds. For example, the “Timestamp” field can represent the time at which a message was sent. As such, when the input state protocol manager 404 causes a message to be retransmitted (i.e., according to preventive blind retransmission), the input state protocol manager 404 can further cause the “Timestamp” field to be updated, even when the messages have the same “Sequence ID.”

In one or more implementations, a control message may include a control header (as discussed above) and a message body. In at least one implementation, the input state protocol manager 404 can format the message body of a control message as a control frame. The input state protocol manager 404 can generate various types of control frames, where each type of control frame has a custom format. The input state protocol manager 404 can use the different types of control frames to authorize an input connection, describe the capabilities of the video game input device 120, etc. In at least one implementation, the input state protocol manager 404 can generate control frames with types including: “Device_Info,” “Declare_Key,” “Declare_Rel,” “Declare_Abs,” “Declare_Rumble,” “Var,” “Retransmit_Factor,” “Ping,” “Auth,” and “Error.” Each type of control frame is now described in greater detail.
“Device_Info” (binary value 0): This type of control frame can define device information. For example, a “Device_Info” control frame can include: “Props” (e.g., some specific device properties of the video game input device 120. This can be used to define axis meanings by accelerometer data. For a gamepad with analog joysticks and accelerometer, two separate devices may be declared), “Device Name Length” (e.g., a length of the device name string), “Vendor, Product” (e.g., standard vendor/product IDs that identify the video game input device 120), “Device Name” (e.g., name of the video game input device 120 as reported to the video game 103. If the video game controller is a virtual controller, the “Device Name” may contain a username of the player). In at least one implementation, the input state protocol manager 404 may require a “Device_Info” control frame when a control message has the “Ini” flag set without the “Ack” flag being set.
“Declare_Key” (binary value 1): This type of control frame can declare a key (or set of keys) supported by the video game input device 120—or other type of input device. For example, a “Declare_Key” control frame can include: “R” which defines a range mode, and a “Key Code” field. When the “R” bit is set, the input state protocol manager 404 can use the “Key Code” field to declare the start of a range. Another “Declare_Key” control frame may be expected to declare the end of the range. This allows for compact declaration of all keys of a keyboard, for example. In at least one implementation, the “Declare_Key” control frame is used for each video game control element on the touch screen display 300 of the video game input device 120 (or button/key supported by a dedicated game controller).
“Declare_Rel” (binary value 2): This type of control frame can declare a relative axis supported by the video game input device 120 (or other input device). For example, a “Declare_Rel” control frame can include a “Rel Code” representing an input key code associated with this axis (e.g., “Rel_X,” “Rel_Y,” etc.). In at least one implementation, the input state protocol manager 404 utilizes a “Declare_Rel” control frame for each relative (infinite) axis such as a mouse, a mouse wheel, or an accelerometer.
“Declare_Abs” (binary value 3): This type of control frame can declare and set up an absolute axis supported by the video game input device 120 (or other input device). For example, a “Declare_Abs” control frame can include: “Abs Code” that can include a corresponding input code associated with this axis (“Abs_X,” “Abs_Y,” etc.), “Default” that can specify the rest value (e.g., zero), and “Maximum” that can specify a maximum value for the axis. For instance, to set an axis that can go from −100 to 100, the input state protocol manager 404 can set “Default” to 100 and “Maximum” to 200.
“Declare_Rumble” (binary value 4): This type of control frame can declare force feedback capabilities of the video game input device 120 (or other input device). For example, a “Declare_Rumble” control frame can include “RMB Cod” representing the rumble motor code. The input state protocol manager 404 can set “RMB Cod” value as: “RMB_Low” (0) (e.g., low frequency motor) and “RMB_High” (1) (e.g., high frequency motor).
“Var” (binary value 5): This type of control frame can set a variable. For example, a “Var” control frame can include a “Name” (e.g., a name of the variable) and a “Value” (e.g., the value of the variable).
“Retransmit_Factor” (binary value 10): This type of control frame can define the number of retransmits the video game input device 120 (or other input device) can perform for each input state message (e.g., input state group). For example, the “Retransmit_Factor” can include a “Count” representing the number of blind retransmits that should be performed for each input state message (e.g., input state group). In one or more implementations, the input state protocol manager 404 can dynamically adjust the “Count” associated with a “Retransmit_Factor” control frame based on network conditions.
“Ping” (binary value 11): This type of control frame can provide a mechanism to synchronize system clocks of the video game input device 120 (or other input device) and the server(s) 112. For example, a “Ping” control frame can include a “P” bit and a “Received Timestamp”. When “P” is set to 0 in a “Ping” control frame, the input state protocol manager 404 can send it back with “P” set to 1 and the “Received Timestamp” set to the timestamps of the control message's header. The input state protocol manager 404 can send “Ping” control frames at regular intervals from the server(s) 112 to measure round trips and to detect timeouts.
“Auth” (binary value 12): This type of control frame can provide an authorization secret token. For example, an “Auth” control frame can include a “Secret Token” and its corresponding “Secret Token Length.” The input state protocol manager 404 can utilize an “Auth” control frame as an authorization token to connect a remote input device such as the video game input device 120.
“Error” (binary value 13): This type of control frame can provide context about an error that can occur when configuration is refused. For example, an “Error” control frame can include error codes such as: “Unknown” (0), “Max_Input_Reached” (1), “Invalid_Config” (2), “Auth_Failed” (3), “Unsupported_Extension” (4), and “Unrecoverable_Loss” (5).

In one or more implementations, an input state message may include an input state header (as discussed above) and a message body. In at least one implementation, the input state protocol manager 404 can format the message body of an input state message as an input state frame. For example, the input state protocol manager 404 can utilize input state frames to communicate input state group messages. An input state frame can declare a series of input states grouped together into atomic input states (e.g., a consistent view of all the buttons/axis/var that are active at a moment in time). The video game input device 120 can emit an input state group every time a state change is detected relative to the touch screen display 300. In one or more implementations, an input state message can include more than one group of input states in order to implement the preventive blind retransmission protocol 408 without having to duplicate packets. The input state protocol manager 404 can utilize various types of input state frames including:
“Group” (binary value 0): This type of input state frame can bundle input states together. For example, a “Group” input state frame can include a “C” bit. When “C” is set to zero (“Group_States”), the input state protocol manager 404 can group input states as a consistent state of the video game input device 120. When more than one of such groups is present in a single message, the input state protocol manager 404 can decrement the “Sequence ID” from the input state message. When “C” is set to one (“Group_Sub”), the input state protocol manager 404 can group input states together to build a more complex description (e.g., such as with multi-finger touch inputs). A “Group” input state frame can further include a “Length” (e.g., a number of bytes for this group) that the input state protocol manager 404 can use to quickly jump to the next group of input states without parsing in case the “Sequence ID” has already been received. If “C” is set to 0 (“Group_States”) and the “Length” is zero, the input state protocol manager 404 can determine that the video game input device 120 is in an idle state (e.g., all of the video game control elements are in their default state). The input state protocol manager 404 can ignore the “Length” if the “C” is set to one (“Group_Sub”). A “Group” input state frame can also include “Time Delta” which can be a number of milliseconds that separate this group from the input state message timestamp. As groups can be sorted within an input state message in anti-chronological order, the input state protocol manager 404 can subtract the “Time Delta” from the input state message's timestamp.
“Key” (binary value 1): This type of input state frame can set a video game control element (e.g., a key that is pressed). For example, a “Key” input state frame can include a “Code” that represents an input key code pressed (e.g., “Key_A,” “Key_Leftshift,” etc.).
“Rel” (binary value 2): This type of input state frame can set a change of a relative axis. For example, a “Rel” input state frame can include a “Code” (e.g., the input key code associated with this axis) and a “Value” (e.g., the resolved absolute value of the relative move since the last input state expressed in a wrap around 24-bit value).
“Abs” (binary value 3): This type of input state frame can set a change of an absolute axis. For example, an “Abs” input state frame can include a “Code” (e.g., the corresponding input key code associated with this axis) and a “Value” (e.g., the new absolute position for this axis).
“Rumble” (binary value 4): This type of input state frame can set the rumble associated with the video game input device 120 (or other input device). For example, a “Rumble” input state frame can include a “RMB Cod” (e.g., “RMB_Low” (0) or “RMB_High (1)), and a “Frequency” (e.g., the frequency of the motor). The input state protocol manager 404 can send a “Rumble” input state frame to the video game input device 120 for each motor declared by the video game input device 120 during initialization (e.g., handshake).

To further illustrate how the input state protocol manager 404 utilizes the preventive blind retransmission protocol, an example of a connection life cycle between the video game input device 120 and the server(s) 112 is now provided. The example described below includes a textual representation of the input state protocol. It will be understood, however, that the input state protocol may be implemented in its binary format. In the example below, the video game input device 120 may include video game control elements including a D-pad (e.g., with up, down, right, and left buttons), a joystick, and two additional buttons (e.g., an A button and a B button). First, the input state protocol manager 404 can initialize the connection with the video game input device 120:

```
> video game input device 120
Control INI, Session 987, Device 0, Seq 456, Timestamp 0
  DEVICE_INFO
    Vendor: xx
    Product: xx
    Length: 12
    Device Name: Bob's iPhone
  DECLARE_KEY
    Code: BTN_DPAD_UP
  DECLARE_KEY
    Code: BTN_DPAD_DOWN
  DECLARE_KEY
    Code: BTN_DPAD_LEFT
  DECLARE_KEY
    Code: BTN_DPAD_RIGHT
  DECLARE_KEY
    Code: BTN_A
  DECLARE_KEY
    Code: BTN_B
  DECLARE_ABS
    Code: ABS_X
    Default: 512
    Maximum: 1024
  AUTH
    Secret Token: xxx
```

The input state protocol manager 404 can cause the server(s) 112 to respond with an “Ack” message that includes a “Session ID” and “Device ID” that will be included in future messages during this connection life cycle:

< video game 103
Control INI+ACK, Session 987, Device 123, Seq 890, Ack 456,
Timestamp 0 # here seq is the receiver's seq init

At this point, because the server(s) 112 has sent a control message to the video game input device 120, the input state protocol manager 404 can cause the video game input device 120 to send an “Ack” message back to the server(s) 112:

> video game input device 120
Control ACK, Session 987, Device 123, Seq 457, Ack 890,
Timestamp 50

With the video game input device 120 connected, the input state protocol manager 404 can cause the video game input device 120 to transmit input state messages. In this example, the player may have used the video game control elements displayed on the touch screen display 300 of video game input device 120 to go right, then jump, then release all buttons:

```
> video game input device 120 # go right
States Device 123, Seq 457, Timestamp: 123 # Seq is states
sequence
  GROUP
    Code: GROUP_STATES
    Length: <computed length of this groups>
    Time Delta: 0 # the first group's delta is set to 0
  KEY
    Code: BTN_DPAD_RIGHT
> video game input device 120 # jump
States Device 123, Seq 458, Timestamp: 133
  GROUP
    Code: GROUP_STATES
    Length: <computed length of this groups>
    Time Delta: 0
  KEY
    Code: BTN_DPAD_RIGHT
  KEY
    Code: BTN_A
  GROUP # the previous event states are repeated starting
here
    Code: GROUP_STATES
    Length: <computed length of this groups>
    Time Delta: 10 # this is 133-123
  KEY
    Code: BTN_DPAD_RIGHT
> video game input device 120 # release all buttons
States Device 123, Seq 459, Timestamp: 153
  GROUP
    Code: GROUP_STATES
    Length: 0
    Time Delta: 0 # a GROUP with zero Length means all
buttons released
  GROUP
    Code: GROUP_STATES
    Length: <computed length of this groups>
    Time Delta: 20
  KEY
    Code: BTN_DPAD_RIGHT
  KEY
    Code: BTN_A
  GROUP
    Code: GROUP_STATES
    Length: <computed length of this groups>
    Time Delta: 10
  KEY
    Code: BTN_DPAD_RIGHT
```

Following this, the video game input device 120 may disconnect:

> video game input device 120
Control FIN Session 988, Device 123, Seq 459 # Seq is
control sequence
< video game 103
Control FIN+ACK Session 988, Device 123, Seq 892, Ack 458

As further shown in FIG. 4, and as mentioned above, the input state system 102 can include the video game 103. In one or more implementations, the video game 103 can poll input states received from the video game input device 120. The video game 103 can further update gameplay based on these polls. For example, the video game 103 can detect inconsistencies (e.g., dropped messages) from the atomic input states received from the video game input device 120. The video game 103 can further resolve these inconsistencies from the input state information redundancies built into the preventive blind retransmission protocol.

As shown in FIGS. 1 and 4, the server(s) 112 can include one or more physical processors, such as the physical processor 110. The physical processor 110 can generally represent any type or form of hardware-implemented processing unit capable of interpreting and/or executing computer-readable instructions. In one implementation, the physical processor 110 may access and/or modify one or more of the components of the input state system 102. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally, the server(s) 112 can include the memory 106. In one or more implementations, the memory 106 generally represents any type or form of volatile or non-volatile storage device or medium capable of storing data and/or computer-readable instructions. In one example, the memory 106 may store, load, and/or maintain one or more of the components of the input state system 102. Examples of the memory 106 can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Moreover, as shown in FIG. 4, the server(s) 112 can include the additional items 108. On the server(s) 112, the additional items 108 can include the digital video game data 406. In one or more implementations, the digital video game data 406 can include definitions for the input state protocol with preventive blind retransmission, as discussed above. The digital video game data 406 can also include information associated with the video game 103.

In summary, the input state system 102 can increase the speed and accuracy with which video games may be played over a network such as the Internet. For example, as described above, the input state system 102 can utilize a preventive blind retransmission protocol that overcomes the shortfalls of previous protocols by causing a video game controller (e.g., such as the video game input device 120) to transmit an input state in response to a detected input event. The input state system 102 can further cause the video game controller to retransmit the same input state a predetermined number of times without waiting for any acknowledgement messages from the receiver. The input state system 102 further reduces latency by grouping retransmissions of older input states with transmissions of new input states. Thus, the input state system 102 builds a high level of redundancy into the input state transmission without duplicating packets, which can slow down gameplay.

### EXAMPLE EMBODIMENTS

Example 1: A computer-implemented method for blindly transmitting and retransmitting full input states of a video game controller over the Internet such that the corresponding video game can maintain a consistent input state. For example, the method may include receiving, from a video game input device used as a video game controller and in response to user interactions on the video game input device in connection with a video game displayed on a display device: 1) a transmission of a first input state message comprising a first input state of the video game input device, and 2) a predetermined number of retransmissions of the first input state, wherein the retransmissions of the first input state are received without providing an acknowledgement associated with the first input state, receiving, from the video game input device and in response to additional user interactions on the video game input device in connection with the video game: 1) a second input state message comprising a second input state of the video game input device and the first input state of the video game input device, and 2) the predetermined number of retransmissions of the second input state, wherein the retransmissions of the second input state are received without providing an acknowledgement associated with the second input state, and updating gameplay of the video game based on input state information received in the first input state message and the second input state message.
Example 2: The computer-implemented method of Example 1, wherein the user interactions on the video game input device in connection with the video game include at least one of single-finger touch gesture user interactions or multi-finger touch gesture user interactions.
Example 3: The computer-implemented method of any of Examples 1 and 2, further including receiving transmissions of control messages from the video game input device and utilizing the control messages for at least one of an initialization procedure with the video game input device, an authorization procedure with the video game input device, a device configuration procedure with the video game input device, or a disconnect procedure with the video game input device.
Example 4: The computer-implemented method of any of Examples 1-3, further including, in response to receiving a transmission of a control message, generating an acknowledgement message associated with the control message and transmitting the acknowledgement message to the video game input device.
Example 5: The computer-implemented method of any of Examples 1-4, wherein the first input state message, the second input state message, and the control messages further include a device ID associated with the video game input device.
Example 6: The computer-implemented method of any of Examples 1-5, wherein the predetermined number of retransmissions is defined by a retransmit factor included in at least one of the control messages.
Example 7: The computer-implemented method of any of Examples 1-6, wherein the second input state message further includes a time delta that indicates a number of milliseconds that separate the first input state of the video game input device from a timestamp associated with the second input state message.
Example 8: The computer-implemented method of any of Examples 1-7, further including, in response to receiving no input state message transmissions from the video game input device for more than a threshold amount of time, determining that the video game input device is in an idle state.

In some examples, a system may include at least one processor and a physical memory including computer-executable instructions that, when executed by the at least one processor, cause the at least one processor to perform various acts. For example, the computer-executable instructions may cause the at least one processor to perform acts including receiving, from a video game input device used as a video game controller and in response to user interactions on the video game input device in connection with a video game displayed on a display device: 1) a transmission of a first input state message comprising a first input state of the video game input device, and 2) a predetermined number of retransmissions of the first input state, wherein the retransmissions of the first input state are received without providing an acknowledgement associated with the first input state, receiving, from the video game input device and in response to additional user interactions on the video game input device in connection with the video game: 1) a second input state message comprising a second input state of the video game input device and the first input state of the video game input device, and 2) the predetermined number of retransmissions of the second input state, wherein the retransmissions of the second input state are received without providing an acknowledgement associated with the second input state, and updating gameplay of the video game based on input state information received in the first input state message and the second input state message.

Additionally in some examples, a non-transitory computer-readable medium can include one or more computer-executable instructions that, when executed by at least one processor of a computing device, cause the computing device to perform various acts. For example, the one or more computer-executable instructions may cause the computing device to receive, from a video game input device used as a video game controller and in response to user interactions on the video game input device in connection with a video game displayed on a display device: 1) a transmission of a first input state message comprising a first input state of the video game input device, and 2) a predetermined number of retransmissions of the first input state, wherein the retransmissions of the first input state are received without providing an acknowledgement associated with the first input state, receive, from the video game input device and in response to additional user interactions on the video game input device in connection with the video game: 1) a second input state message comprising a second input state of the video game input device and the first input state of the video game input device, and 2) the predetermined number of retransmissions of the second input state, wherein the retransmissions of the second input state are received without providing an acknowledgement associated with the second input state, and update gameplay of the video game based on input state information received in the first input state message and the second input state message.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of,” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, from a video game input device used as a video game controller and in response to user interactions on the video game input device in connection with a video game displayed on a display device:
a transmission of a first input state message comprising a first input state of the video game input device; and
a predetermined number of retransmissions of the first input state, wherein the retransmissions of the first input state are received without providing an acknowledgement associated with the first input state;
receiving, from the video game input device and in response to additional user interactions on the video game input device in connection with the video game:
a second input state message comprising a second input state of the video game input device and the first input state of the video game input device; and
the predetermined number of retransmissions of the second input state, wherein the retransmissions of the second input state are received without providing an acknowledgement associated with the second input state; and
updating gameplay of the video game based on input state information received in the first input state message and the second input state message.

2. The computer-implemented method of claim 1, wherein the user interactions on the video game input device in connection with the video game comprise at least one of single-finger touch gesture user interactions or multi-finger touch gesture user interactions.

3. The computer-implemented method of claim 1, further comprising:
receiving transmissions of control messages from the video game input device; and
utilizing the control messages for at least one of an initialization procedure with the video game input device, an authorization procedure with the video game input device, a device configuration procedure with the video game input device, or a disconnect procedure with the video game input device.

4. The computer-implemented method of claim 3, further comprising, in response to receiving a transmission of a control message, generating an acknowledgement message associated with the control message and transmitting the acknowledgement message to the video game input device.

5. The computer-implemented method of claim 3, wherein the first input state message, the second input state message, and the control messages further comprise a device ID associated with the video game input device.

6. The computer-implemented method of claim 3, wherein the predetermined number of retransmissions is defined by a retransmit factor included in at least one of the control messages.

7. The computer-implemented method of claim 1, wherein the second input state message further comprises a time delta that indicates a number of milliseconds that separate the first input state of the video game input device from a timestamp associated with the second input state message.

8. The computer-implemented method of claim 1, further comprising, in response to receiving no input state message transmissions from the video game input device for more than a threshold amount of time, determining that the video game input device is in an idle state.

9. A system comprising:
at least one physical processor; and
physical memory comprising computer-executable instructions that, when executed by the at least one physical processor, cause the at least one physical processor to perform acts comprising:
receiving, from a video game input device used as a video game controller and in response to user interactions on the video game input device in connection with a video game displayed on a display device:
a transmission of a first input state message comprising a first input state of the video game input device; and
a predetermined number of retransmissions of the first input state, wherein the retransmissions of the first input state are received without providing an acknowledgement associated with the first input state;
receiving, from the video game input device and in response to additional user interactions on the video game input device in connection with the video game:
a second input state message comprising a second input state of the video game input device and the first input state of the video game input device; and
the predetermined number of retransmissions of the second input state, wherein the retransmissions of the second input state are received without providing an acknowledgement associated with the second input state; and
updating gameplay of the video game based on input state information received in the first input state message and the second input state message.

10. The system of claim 9, wherein the user interactions on the video game input device in connection with the video game comprise at least one of single-finger touch gesture user interactions or multi-finger touch gesture user interactions.

11. The system of claim 9, further comprising computer-executable instructions that, when executed by the at least one physical processor, cause the at least one physical processor to perform acts comprising:
receiving transmissions of control messages from the video game input device; and
utilizing the control messages for at least one of an initialization procedure with the video game input device, an authorization procedure with the video game input device, a device configuration procedure with the video game input device, or a disconnect procedure with the video game input device.

12. The system of claim 11, further comprising computer-executable instructions that, when executed by the at least one physical processor, cause the at least one physical processor to perform an act comprising, in response to receiving a transmission of a control message, generating an acknowledgement message associated with the control message and transmitting the acknowledgement message to the video game input device.

13. The system of claim 11, wherein the first input state message, the second input state message, and the control messages further comprise a device ID associated with the video game input device.

14. The system of claim 11, wherein the predetermined number of retransmissions is defined by a retransmit factor included in at least one of the control messages.

15. The system of claim 9, wherein the second input state message further comprises a time delta that indicates a number of milliseconds that separate the first input state of the video game input device from a timestamp associated with the second input state message.

16. The system of claim 9, further comprising computer-executable instructions that, when executed by the at least one physical processor, cause the at least one physical processor to perform an act comprising, in response to receiving no input state message transmissions from the video game input device for more than a threshold amount of time, determining that the video game input device is in an idle state.

17. A non-transitory computer-readable medium comprising one or more computer-executable instructions that, when executed by at least one processor of a computing device, cause the computing device to:
receive, from a video game input device used as a video game controller and in response to user interactions on the video game input device in connection with a video game displayed on a display device:
a transmission of a first input state message comprising a first input state of the video game input device; and
a predetermined number of retransmissions of the first input state, wherein the retransmissions of the first input state are received without providing an acknowledgement associated with the first input state;
receive, from the video game input device and in response to additional user interactions on the video game input device in connection with the video game:
a second input state message comprising a second input state of the video game input device and the first input state of the video game input device; and
the predetermined number of retransmissions of the second input state, wherein the retransmissions of the second input state are received without providing an acknowledgement associated with the second input state; and
update gameplay of the video game based on input state information received in the first input state message and the second input state message.

18. The non-transitory computer-readable medium of claim 17, further comprising one or more computer-executable instructions that, when executed by the at least one processor of the computing device, cause the computing device to:
receive transmissions of control messages from the video game input device; and
utilize the control messages for at least one of an initialization procedure with the video game input device, an authorization procedure with the video game input device, a device configuration procedure with the video game input device, or a disconnect procedure with the video game input device.

19. The non-transitory computer-readable medium of claim 18, further comprising one or more computer-executable instructions that, when executed by the at least one processor of the computing device, cause the computing device to, in response to receiving a transmission of a control message, generate an acknowledgement message associated with the control message and transmit the acknowledgement message to the video game input device.

20. The non-transitory computer-readable medium of claim 19, wherein the second input state message further comprises a time delta that indicates a number of milliseconds that separate the first input state of the video game input device from a timestamp associated with the second input state message.
